(19) United States
(12) Patent Application Publication
(10) Pub. No.: US 2006/0234635 A1
(43) Pub. Date: Oct. 19, 2006

(54) Mobile communication device and method for controlling such a mobile communication device

(76) Inventors: John Riordan, Bern (CH); Thomas Jakob, Berne (CH); Olivier Krone, Fribourg (DE); Numa Schmeder, Berne (CH)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/568,068

(22) PCT Filed: Aug. 13, 2004
(86) PCT No.: PCT/EP04/51795

§ 371 Date: Feb. 13, 2006

(30) Foreign Application Priority Data
Aug. 14, 2003 (EP) 03405594.7

(51) Int. Cl. H04B 17/00

(52) U.S. Cl. 455/67.11

(57) ABSTRACT

A mobile communication device and a method for a mobile communication device, including a multiplicity of modes of operation with different operational functions. The mobile communication device encompasses sensors for determining body-related parameters of the user and/or environmental parameters of the mobile communication device. The mobile communication device includes a selection module for evaluating the body-related parameters of the user and/or the environmental parameters of the mobile communication device, and the mobile communication device includes an operational mode module for adapting the respective mode of operation of the mobile communication device according to the evaluation data for the body-related parameters and/or of the environmental parameters. The mobile communication device can also include a mobile radio device.

The invention relates to a mobile communication device comprising a multiplicity of modes of operation with different operational functions, and a method for controlling the modes of operation, at least one operational function being determined through the respective mode of operation of the mobile communication device. The invention relates in particular to such a user-controlled mobile radio device.

In recent years, the number of mobile users of mobile radio networks has increased worldwide exponentially, and continues to climb. Mobile communication devices thus accompany people in almost all walks of life or life situations. It is already possible today in the state of the art for the user of such mobile receiving devices to create a multiplicity of user profiles and thereby be able to adapt the operational functions to the current environment in which the user is located at the moment. This is only possible manually, however, and requires a definition beforehand by the user of the different modes of operation.

Described in the document DE 196 39 492 is an automatic help activation system. Upon the occurrence of defined critical conditions of measuring modules (such as e.g. for measuring time lapse, pulse, terrestrial altitude, humidity, force of impact, etc.) a warning is given optically or acoustically that an activation of the system is imminent. If this warning is not acknowledged within a defined time, then data, such as e.g. geographic location and personal data, are transmitted by mobile radio to a known number, a speech module converting the data into speech signals.

Described in the document DE 202 14 189 is a system for transmission of bodily function values of a patient. At least one bodily function value is measured by a measuring device, the measuring device transmitting a measuring value-specific piece of information wirelessly to a mobile transmitting and receiving device. The mobile transmitting and receiving device transmits this measuring-value specific information in the form of an electronic message in a mobile radio network.

It is an object of this invention to propose a new mobile communication device and a method for controlling different modes of operation of a mobile communication device which do not have the above-mentioned drawbacks of the state of the art. In particular, a simple and efficient automated method and such a device should be proposed which allow the mode of operation of the mobile communication device to be adapted automatically to a changed environment without any help from the user.

This object is achieved according to the present invention in particular through the elements of the independent claims. Further advantageous embodiments follow moreover from the dependent claims and from the specification.

In particular these objects are achieved through the invention in that the mobile communication device comprises a multiplicity of modes of operation with different operational functions, the mobile communication device encompassing sensors for determining body-related parameters of the user and/or environmental parameters of the mobile communication device, the mobile communication device comprises a selection module for evaluating the body-related parameters of the user and/or environmental parameters of the mobile communication device, and the mobile communication device comprises an operational mode module for adapting the respective mode of operation of the mobile communication device according to the evaluation data for the body-related parameters and/or environmental parameters. This embodiment variant has the advantage, among others, that the mode of operation of the mobile communication device can be adapted automatically to a changed environment and/or other conditions without any help from the user. Furthermore, by means of the automatic selection of the mode of operation, in particular monitoring functions and alarm functions can be triggered or respectively performed.

In an embodiment variant, the mobile communication device comprises a sensor for measuring the cardiac rhythm and/or adrenaline level and/or oxygen content of the blood and/or blood sugar content and/or body temperature and/or body position and/or type of movement and/or direction of movement and/or vocal activity and/or pitch of the voice and/or brain activity of the user as body-related parameters. This embodiment variant has the advantage, among others, that, e.g. in the case of diabetics, the blood sugar level can be monitored automatically, the ringing tone can be adapted automatically to external conditions (active phase of the user, resting phase of the user), or in general that the mode of operation can be adapted to external conditions and/or user parameters. Further advantages follow from the specific choice of sensor. Thus, for example, the measurement of the voice activity and/or voice pitch (louder or raising of the voice) can indicate an emotional stress situation for the user, in which, for example, unsolicited promotional calls or calls from certain numbers or calls in general or messages of all kinds are not necessarily desirable and/or it can indicate, for instance, an automatic transfer of the calls to an answering machine. In particular, the brain activity can also be used for example, e.g. α/β/γ waves for recognition of active phases (high α activity) and/or resting phases (γ activity) and/or emergency situations (possibly changed β activity). It is to be pointed out that the number and/or type of sensors is not limited in any way by the above list, but instead the scope of protection relates in general to all possible measurement parameters. Said sensors can be installed in the mobile communication device, or can be connected to the mobile communication device via a wireless or wired connection.

In another embodiment variant, the mobile communication device comprises a sensor for measuring the noise level and/or air temperature and/or light values of the surrounding area of the communication device as environmental parameters. This embodiment variant has the same advantages, among others, as the preceding embodiment variant. Through the combination of body-related and environmental parameters, the selection module can work more finely and more plausibly. In a loud environment, for example, a louder ringing tone can be set automatically, and/or with a decrease in light values in combination with the body position, this can be interpreted as sleep or resting phase of the user.

In a further embodiment variant, the mobile communication device comprises a mobile radio device. This embodiment variant has the advantage, among others, that owing to the wide distribution of mobile radio devices and their presence in almost all situations of modern life, such an embodiment variant can especially make sense.

In a further embodiment variant, the mobile communication device comprises a play station. This embodiment variant has the advantage, among others, that owing to the wide distribution of play stations and their presence in almost all situations of modern life, such an embodiment variant can especially make sense.

In another embodiment variant, the mobile communication device comprises an expert module by means of which the selection of the mode of operation depending upon body-related parameters of the user and/or environmental parameters of the mobile communication device is able to be carried out in a self-learning way based on pattern recognition. The expert module can include e.g. at least one neural network for pattern recognition. This embodiment variant has the advantage, among others, that the automatic selection of the most suitable mode of operation with certain parameters improves over time in a self-adapting way, without a complicated programming of the communication devices or the like being required of the user.

In a further embodiment variant, the selection module comprises a predefinable threshold for triggering alarm functions by means of the mobile communication device for at least one body-related parameter and/or for at least one environmental parameter. This embodiment variant has the advantage, among others, that monitoring and alarm functions for a user can be achieved by means of the mobile communication device in an especially simple and efficient way.

In a further embodiment variant, the sensors, for example pressure sensors, are actuated by the user, the corresponding measuring signals are recorded as environmental parameters, and the applications running on the mobile communication device are controlled by the operational mode module. This embodiment variant has the advantage, among others, that a play station can be achieved by means of the mobile communication device. If, in addition, the adrenaline value of the user is captured by a further sensor, the excitement potential of the game can be correspondingly controlled for the user to ensure a certain attractiveness and at the same time prevent health risks (for instance epileptic seizures).

It should be stated here that, in addition to the method according to the invention, the invention also relates to a device for carrying out this method. It is not limited furthermore to mobile radio devices, but relates in general to mobile communication devices of all kinds.

Embodiment variants of the present invention will be described in the following with reference to examples. The examples of the embodiments are illustrated by the following attached figures:

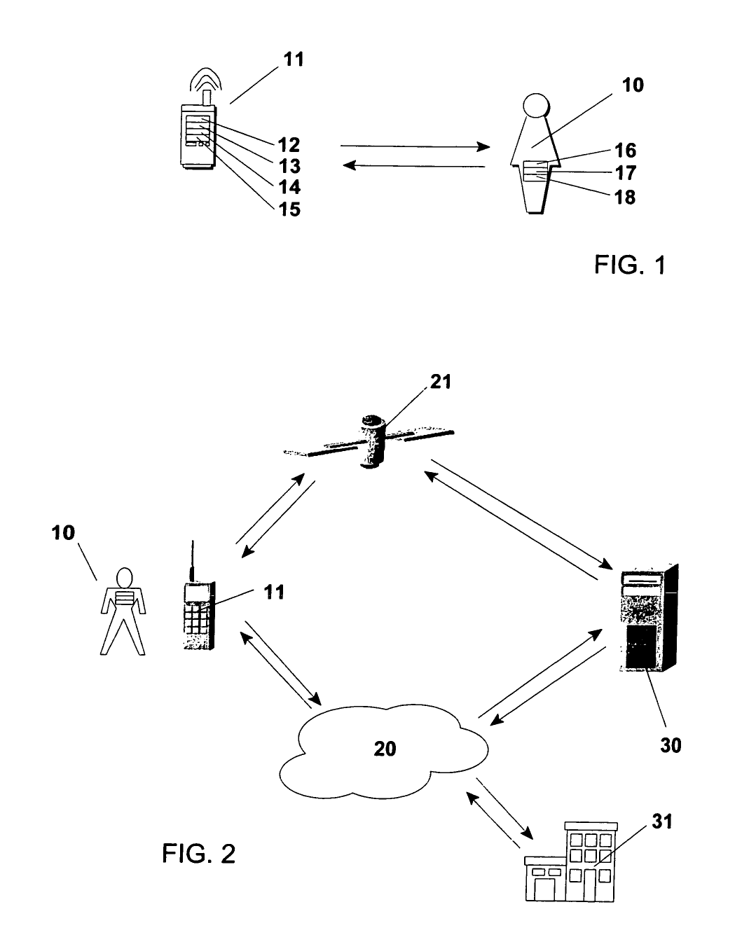

FIG. 1 shows a block diagram representing schematically the mobile communication device 11 with a user 10. The body-related parameters of the user and/or environmental parameters of the mobile communication device are able to be determined by means of the sensors and/or measuring devices 12 to 18.

FIG. 2 likewise shows a block diagram representing schematically the mobile communication device 11 with a user 10. The measuring parameters of the sensors and/or measuring devices 12 to 18 can be transmitted via a communication network 20/21 to a central unit 30, e.g. upon reaching predefinable threshold values, and be used, for instance, to alert an emergency call service 31 as used by doctors on emergency call or the police.

FIG. 1 illustrates schematically an architecture that can be used to achieve the invention. In this embodiment example, the mobile communication device comprises a multiplicity of modes of operation with different operational functions. In FIG. 1 the reference numeral 11 relates to such a mobile communication device or a so-called mobile node having the necessary infrastructure, including hardware and software components, to achieve a described method and/or system according to the invention. Understood by mobile communication device 11 are, among other things, all possible so-called Customer Premise Equipment (CPE) which are designed for use at various network locations and/or in various networks. In particular, the mobile communication device can be, for instance, a mobile radio device, a laptop, a PDA or a play station. The mobile communication device 11 possesses one or more different physical network interfaces, which can also support a multiplicity of different network standards. The physical network interfaces of the mobile communication device can comprise e.g. interfaces to Ethernet or another wired LAN (Local Area Network), Bluetooth, GSM (Global System for Mobile Communication), GPRS (Generalized Packet Radio Service), USSD (Unstructured Supplementary Services Data), UMTS (Universal Mobile Telecommunications System) and/or WLAN (Wireless Local Area Network). The communication networks 20/21 comprise, for example, a mobile radio network, such as a terrestrial mobile radio network, e.g. a GSM or UMTS network, or a satellite-based mobile radio network, and/or one or more fixed networks, for example the public switched telephone network, the worldwide packet-oriented IP backbone network or a suitable LAN (Local Area Network) or WAN (Wide Area Network). As already mentioned in part, the communication over the mobile radio network 20/21 can take place, for example, by means of special short messages, e.g. SMS (Short Message Services), MMS (Multimedia Message Services), EMS (Enhanced Message Services), via a signalling channel, such as e.g. USSD (Unstructured Supplementary Services Data) or other technologies, such as MExE (Mobile Execution Environment), GPRS (Generalized Packet Radio Service), WAP (Wireless Application Protocol) or UMTS (Universal Mobile Telecommunications System), or a user service channel. The operational functions can comprise e.g. ringing tone, ringing volume, vibration strength, light signals, display of logos and pictures on the display of the mobile communication device, e.g. in the case of incoming calls and/or alarm functions such as e.g. calendar alarm functions. The determination of the values of the individual operational functions form in their entirety a particular mode of operation. The mobile communication device 11 comprises sensors and/or measuring devices 12, . . . , 18 for determining body-related parameters of the user and/or environmental parameters of the mobile communication device. The sensors can comprise e.g. a sensor for measuring the heart rhythm of the user, for measuring the blood pressure of the user, for measuring the adrenaline level of the user, for measuring the oxygen content of the blood of the user, for measuring the position of the body of the user, for measuring the type of movement and/or the direction of movement of the user, for measuring the voice activity of the user, as body-related parameters, and/or for measuring the noise level of the environment, the air pressure of the environment and/or for detecting atomic, biological or chemical elements of the environment and/or for detecting the time of day. The sensors 12, . . . , 18 can also comprise, however, e.g. a GPS module (Global Positioning Module) for determining the absolute position of the communication device 11. The sensors and/or detectors can capture measurement values directly or indirectly. For example, a temperature sensor in the housing of the mobile communication device can capture the temperature of the housing and thus, indirectly, also the temperature of the environment. Each measurement parameter can influence the mode of operation. When, for instance, the body position of the user 10 is measured, the mobile communication device is able to switch over automatically to a soundless mode of operation when the position of the body of the user 10 is horizontal (lying, sleeping, resting). The sensors 12, . . . , 18 can be put e.g. directly on the user 16, . . . , 18, for measuring the body temperature, the pulse, for example, or can be integrated 12, . . . , 15 in the mobile communication device 11. If they are put directly on the user, they can transmit the rough measurement signals and/or processed measurement data wirelessly or via cable connection to the mobile communication device 11. The same applies for the environmental parameters. The mobile communication device 11 further comprises, i.e. contains, or is connected to, a selection module for evaluation of the body-related parameters of the user and/or environmental parameters of the mobile communication device. If one or more of the body-related parameters of the user and/or environmental parameters change, the mode of operation of the mobile communication device will be adapted to the changed conditions (sleeping, driving) by means of an operational mode module. The selection module and the operational mode module may be achieved through software and/or hardware in the mobile communication device. The selection module and the operational mode module can be correspondingly implemented in the communication device, or connected to the communication device via a wireless or wired communication interface, for example via a communication network 20, 21.

FIG. 2 likewise illustrates schematically an architecture that can be used to achieve the invention. In this embodiment example, for at least one body-related parameter and/or environmental parameter, the selection module of the mobile communication device further comprises a predefinable threshold value for automatic triggering of alarm functions. Mentioned here as a possible example are sensors for measuring the blood sugar level, e.g. for diabetics and/or athletes. If the blood sugar level sinks below a predetermined threshold, or if it rises above a predetermined threshold, then an alarm mode of the mobile communication unit is automatically triggered. In the alarm mode, an emergency call service such as e.g. the emergency call service for physicians or the police can be alerted. The alert can also include in particular position indications for the mobile communication device 11 as well as body-related parameters for the user 10. This can take place, for example, via the mentioned networks 20/21. The emergency call service 31 can be thereby alerted, for example directly by the mobile communication device 11, or the evaluation data can be transmitted to a central unit 30, which can then activate e.g. further monitoring functions in the mobile communication device 11 (such as e.g. location monitoring by means of the GPS module), can undertake a direct monitoring of the user 10 via the mobile communication device 11 and/or can fulfil alarm functions on its own.

It is important to point out that, as an embodiment example, the mobile communication device can further comprise an expert module, by means of which the selection of the operating mode by the user depending upon the body-related parameters of the user 10 and/or environmental parameters for the mobile communication device 11 is automatically learnable based on pattern recognition, e.g. patterns of the user behavior. The software for the expert module can be achieved as applet, and can be transmitted via the communication network to the mobile communication device. The expert module for pattern recognition can comprise e.g. at least one neural network. Conventional static and/or dynamic neural networks may be chosen, for example, as neural networks, such as e.g. feed-forward (heteroassociative) networks, such as a perceptron or a multi-layer perceptron (MLP), but also other network structures are conceivable, such as e.g. recurrent network structures. The differing network structure of the feed-forward networks in contrast to networks with feedback (recurrent networks) determines the way in which information is processed by the network. In the case of a static neural network, the structure is supposed to ensure the replication of static characteristic fields with sufficient approximation quality. The neural networks can be achieved in the expert module through software or hardware. For this embodiment example, a multilayer perceptron may be chosen as an example. An MLP consists of a number of neuron layers having at least one input layer and one output layer. The structure is directed strictly forward, and belongs to the group of feed-forward networks. Neural networks quite generally map an m-dimensional input signal onto an n-dimensional output signal. The information to be processed is, in the feed-forward network considered here, received by a layer having input neurons, the input layer. The input neurons process the input signals, and forward them via weighted connections, so-called synapses, to one or more hidden neuron layers, the hidden layers. From the hidden layers, the signal is transmitted, likewise by means of weighted synapses, to neurons of an output layer which, in turn, generates the output signal of the neural network. In a forward directed, completely connected MLP, each neuron of a certain layer is connected to all neurons of the following layer. The choice of the number of layers and neurons (network nodes) in a particular layer is, as usual, to be adapted to the respective problem, here e.g. to, among other things, the number of body-related parameters and/or environmental parameters and/or modes of operation. The simplest possibility is to find out the ideal network structure empirically. In so doing, it is to be heeded that if the number of neurons chosen is too large, the network, instead of learning, works purely image-forming, while with too small a number of neurons it comes to correlations of the mapped parameters. Expressed differently, the fact is that if the number of neurons chosen is too small, the function can possibly not be represented. However, upon increasing the number of hidden neurons, the number of independent variables in the error function also increases. This leads to more local minima and to the greater probability of landing in precisely one of these minima. In the special case of back propagation, this problem can be at least minimized, e.g. by means of simulated annealing. In simulated annealing, a probability is assigned to the states of the network. In analogy to the cooling of liquid material from which crystals are produced, a high initial temperature T is chosen. This is gradually reduced, the lower the slower. In analogy to the formation of crystals from liquid, it is assumed that if the material is allowed to cool too quickly, the molecules do not arrange themselves according to the grid structure. The crystal becomes impure and unstable at the locations affected. In order to prevent this, the material is allowed to cool down so slowly that the molecules still have enough energy to jump out of a local minimum. In the case of neural networks, nothing different is done: additionally, the magnitude T is introduced in a slightly modified error function. In the ideal case, this then converges toward a global minimum. For the application with the user-controlled mobile communication device, in the case of MLP, neural networks having an at least three-layered structure have proved useful. That means that the networks comprise at least one input layer, a hidden layer, and an output layer. The neural networks of the expert module can now be trained continuously or periodically according to the operational mode selection of the user 10. By means of possible corrections of the user 10, the adaptation of the modes of operation thus constantly improves over time, using the selection module, based on the body-related parameters and/or environmental parameters. Thus the user 10 is not always sleeping, for instance, when the sensor registers a horizontal body position for the user 10. If the user is lying down in the bedroom, for example, it is highly probable that he is resting, making a soundless mode of operation expedient, whereas he will prefer a louder-than-normal mode of operation sitting in the TV chair, for example, or on the lawn at the swimming pool, although his body position there can also be horizontal. The expert module can learn to select here the correct mode of operation in an adaptive way, even in such complex contexts, e.g. from the data of the sensor for the body position, the pulse data and/or the data of the GPS module.

1-18. (canceled)

19. A mobile communication device, including a multiplicity of modes of operation with different operational functions, body-related parameters of a user and/or environmental parameters of the mobile communication device being able to be captured by the mobile communication device by sensors and/or measuring devices, the mobile communication device comprising:
a selection module configured to evaluate the body-related parameters of the user and/or environmental parameters of the mobile communication device; and
an operational mode module configured to adapt a respective mode of operation of the mobile communication device according to evaluation data for the body-related parameters and/or environmental parameters.

20. The mobile communication device according to claim 19, wherein a body-related parameter of the user that is able to be captured by the mobile communication device by sensors includes a cardiac rhythm and/or an adrenaline level and/or an oxygen content of blood and/or a blood sugar content and/or a body position and/or a brain activity and/or a type of movement and/or a direction of movement and/or a vocal activity and/or a pitch of the voice of the user as body-related parameter.

21. The mobile communication device according to claim 19, wherein an environmental parameter for the environment of the mobile communication device that is able to be captured by the mobile communication device by sensors includes a noise level and/or an air temperature and/or a light value for the surrounding area of the communication device.

22. The mobile communication device according to claim 19, wherein the mobile communication device further comprises a mobile radio device connectible to a communication network.

23. The mobile communication device according to claim 19, wherein the mobile communication device further comprises a play station connectible to a communication network.

24. The mobile communication device according to claim 19, wherein the mobile communication device further comprises an expert module, by which selection of the mode of operation by the user based on pattern recognition in dependence upon the body-related parameters of the user and/or environmental parameters for the mobile communication device is trainable.

25. The mobile communication device according to claim 24, wherein the expert module comprises at least one neural network for pattern recognition.

26. The mobile communication device according to claim 19, wherein the selection module comprises a predefinable threshold for triggering alarm functions by the mobile communication device for at least one body-related parameter and/or for at least one environmental parameter.

27. The mobile communication device according to claim 19, wherein the mobile communication device comprises at least one sensor configured to be actuated by the user.

28. A method for controlling different modes of operation of a mobile communication device, different operational functions being controlled through respective modes of operation of the mobile communication device, and body-related parameters of the user and/or environmental parameters of the mobile communication device being captured by the mobile communication device by sensors, the method comprising:
evaluating determined body-related parameters of the user and/or environmental parameters of the mobile communication device by a selection module; and
adapting by an operational mode module respective modes of operation of the mobile communication device based on evaluation data for the body-related parameters and/or for the environmental parameters.

29. The method for controlling different modes of operation of a mobile communication device according to claim 28, wherein heart rhythm and/or blood pressure and/or adrenaline level and/or oxygen content of blood and/or blood sugar content and/or body position and/or brain activity and/or type of movement and/or direction of movement and/or voice activity and/or pitch of the voice of a user is captured as the body-related parameters by the mobile communication device by at least one sensor.

30. The method for controlling different modes of operation of a mobile communication device according to claim 28, wherein noise level and/or air temperature and/or light values of surrounding area is captured as the environmental parameters by the mobile communication device by at least one sensor.

31. The method for controlling different modes of operation of a mobile communication device according to claim 28, wherein a mobile radio device connectible to a communication network is used as the mobile communication device.

32. The method for controlling different modes of operation of a mobile communication device claim 28, wherein a play station connectible to a communication network is used as the mobile communication device.

33. The method for controlling different modes of operation of a mobile communication device according to claim 28, wherein an expert module is trained by pattern recognition based on selection of the mode of operation by the user in dependence upon the body-related parameters of the user and/or environmental parameters of the mobile communication device, and is used for control of the selection of the modes of operation.

34. The method for controlling different modes of operation of a mobile communication device according to claim 33, wherein the expert module trains the pattern recognition using at least one neural network.

35. The method for controlling different modes of operation of a mobile communication device according to claim 28, wherein at least one threshold value is defined for one or more body-related parameters and/or for one or more environmental parameters, whereby upon reaching the threshold value, an alarm function is triggered by the selection module.

36. The method for controlling different modes of operation of a mobile communication device according to claim 28, wherein at least one sensor is actuated by a user.
